(19) United States
(12) Patent Application Publication
(10) Pub. No.: US 2015/0030743 A1
(43) Pub. Date: Jan. 29, 2015

(54) METHOD AND EDIBLE ARTICLE OF MANUFACTURE

(71) Applicant: Gregory Anders, Bellingham, WA (US)

(72) Inventor: Gregory Anders, Bellingham, WA (US)

(21) Appl. No.: 14/149,900

(22) Filed: Jan. 8, 2014

Related U.S. Application Data
(60) Provisional application No. 61/859,372, filed on Jul. 29, 2013.

(51) Int. Cl. A23L 1/01; A23L 1/221

(52) U.S. Cl. CPC A23L 1/0107; A23L 1/221
USPC 426/531; 426/438; 426/439

(57) ABSTRACT

A method of manufacturing an edible article, namely a fried product such as popcorn infused with various flavorings, and more particularly, to methods of making fried products infused with various flavorings.

### I. BACKGROUND

A. Field of Invention

This invention generally relates to methods and articles of manufacturing of an edible article, namely fried snack products infused with various flavorings.

B. Description of the Related Art

It is well known in the art to produce fried snack products and it is known to produce fried snack products with various flavors, both natural and artificial. For example, it is known to flavor popcorn with butter, and salt, cheese, and occasionally with more non-traditional flavors such as bacon. One of the flavors recently added to popcorn, which is enjoying popularity, is that of jalapeno. Jalapeno is a type of pepper that provides excellent flavor to media such as popcorn. One known method of flavoring fried snack products is to spray or pour a flavoring substance on the snack product after it has been cooked. Next comes a mixing step whereas the product is stirred, shaken, or turned in an attempt to coat the snack with the flavoring. One such method is described in U.S. Pat. No. 4,888,186. The results are often unsatisfactory as the flavor coating is often unevenly applied to the snack. Also a significant amount of the flavoring substance may not attach itself to the snack and thus is wasted. The additional step of coating the snack after cooking is undesirable as it requires extra time and can be inconvenient. This method is also limited to flavorings that can be applied as a coating, such as salt, or an artificial powdered flavoring. Also the induced flavor only exists on the exterior of the snack and thus does not provide a deep, richly flavored snack. Additionally, with the flavoring on the exterior of the snack, the consumer's hands become soiled during consumption of the snack.

A known attempted solution to these problems is to coat the uncooked snack with a flavoring substance before frying. One such method is described in U.S. Pat. No. 3,704,133. This method does not address the problem of uneven coating of the snack or the resulting waste of the flavoring substance. Also this method does not address the problem of flavorings being limited to flavorings able to be applied as a coating.

Another known attempted solution to these problems is to add flavorings to the cooking oil and cook the snack in the flavored oil. In this method the flavoring is induced to the snack by the oil splashing over the snack during the frying process. One such method is described in U.S. Pat. No. 3,961,091. But this method does not increase the intensity of the snack flavor as the added flavoring largely remains on the exterior of the snack. Also the method uses imitation flavorings or flavorings that can be encapsulated. Neither of these flavorings elements create an intense flavor that is close to the natural flavor desired in the snack product.

What is needed is a fried snack product and method of producing said product where the flavoring is evenly applied, with a wider variety of flavorings, is convenient to consume, and there is less waste while producing the snack. Also needed is a snack with vivid, intense flavor that is closer to the intended snack flavor.

### II. SUMMARY

According to one embodiment of this invention, a method to produce a flavor infused cooking oil may comprise the steps of: (A) providing a cooking vessel, heating element, cooking oil, and flavoring element; (B) pouring cooking oil into cooking vessel; (C) placing cooking vessel on heating element; (D) heating cooking vessel until cooking oil is at desired temperature; (E) adding flavoring agent to cooking oil; and (F) cooking flavoring agent until the desired appearance, amount of flavor intensity, and consistency is achieved.

According to another embodiment of this invention, a method to produce an infused snack product may comprise the steps of: (A) providing a cooking vessel, heating element, flavored cooking oil, and uncooked food items; (B) pouring flavored cooking oil into cooking vessel; (C) placing cooking vessel on heating element; (D) heating cooking vessel until flavored cooking oil is at desired temperature; (E) adding uncooked food items to cooking oil; and (F) cooking food items until the desired appearance, flavor intensity, and consistency is achieved.

According to yet another embodiment of this invention a combination snack product may comprise: an amount of a first flavor infused snack product; an amount of a second flavor infused snack product; and packaging the first and second flavor infused snack products together in a container.

One advantage of this invention is that the flavoring is evenly applied to the snack product.

Another advantage of this invention is less waste results while producing the snack product.

Yet another advantage of this invention is a snack product is produced with more vivid, intense flavor and a wider variety of flavorings is achievable.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows a cooking vessel 10 containing cooking oil 12, and sitting on a heating element 11.

FIG. 2 shows popped popcorn kernels 14 and a fresh, uncooked jalapeno disc 16.

FIG. 3 shows popped popcorn kernels already infused with jalapeno flavor, mixed together with fried jalapeno chips 20.

### IV. DETAILED DESCRIPTION

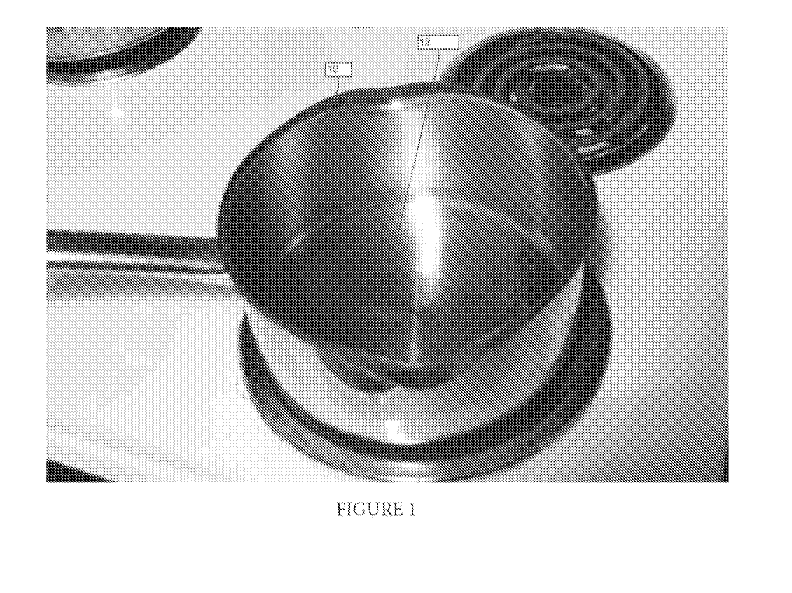

Referring now to the drawings wherein the showings are for purposes of illustrating embodiments of the invention only and not for purposes of limiting the same, and wherein like reference numerals are understood to refer to like components, flavored cooking oil 13 may be produced in the following innovative manner. FIG. 1 shows a cooking vessel 10 into which cooking oil 12 may be placed. The cooking vessel 10 may be a conventional pan suitable for heating cooking oil 12 to a temperature sufficient to cook the selected flavoring agent. A heating element 11 may be used to heat the cooking oil 12. The temperature range used with cooking oil 12 to cook an item is known in the art and may be chosen with the sound judgment of a person of skill in the art. Next a flavoring agent may be placed in the cooking oil 12. The agent is allowed to cook until the agent has infused the cooking oil 12 with the desired flavor. Non-limiting examples of flavoring agents are jalapeno peppers, non-jalapeno peppers, pickles, bacon, garlic, ginger, and basil. At this point the cooked flavoring agent may be removed from the cooking vessel 10. The remaining oil has now been infused with a vivid and intense flavor that is truer to the natural flavor of the original flavoring agent. This oil is referred to as flavored cooking oil 13.

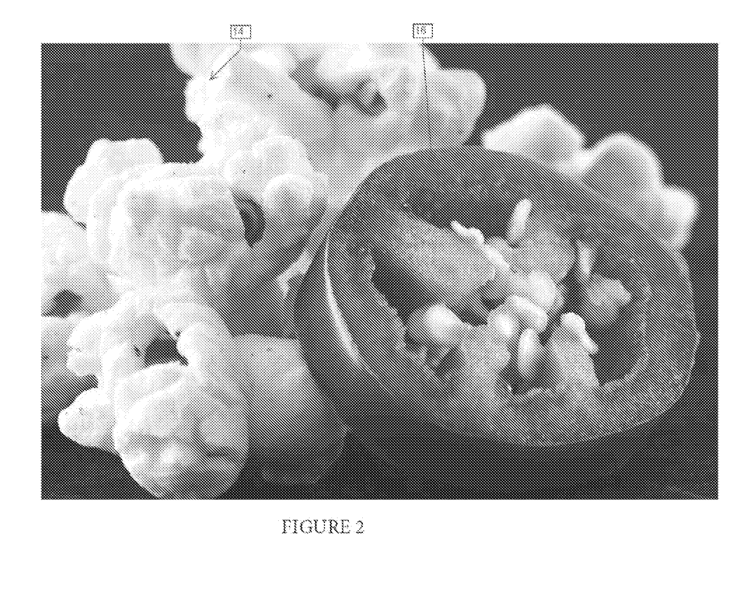

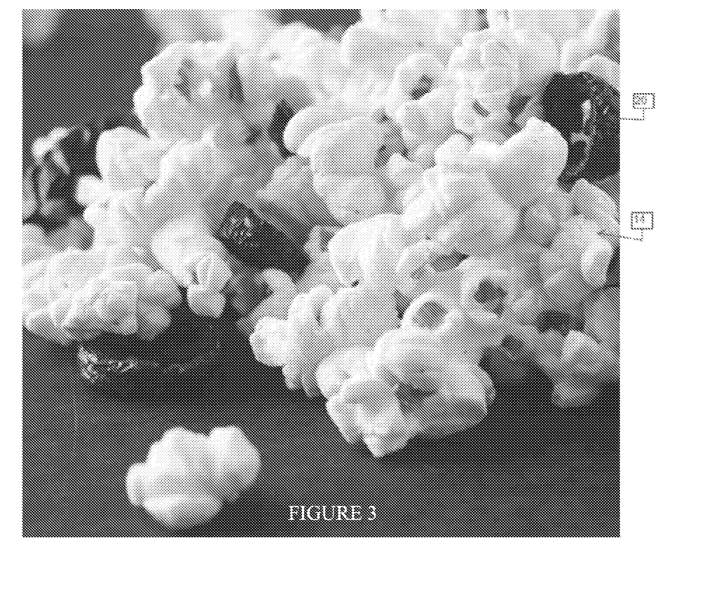

In one non-limiting example of this innovative method, jalapeno peppers are cut into discs 16, as shown in FIGS. 2 and 3. The discs 16 can be of various thicknesses, but the preferred thickness is between 1 mm and 90 mm. Next the jalapeno discs 16 are placed into the hot cooking oil 12 and allowed to cook, turning from a fresh green color (as in FIG. 2) to a dark grey of black as shown in FIG. 3. The moisture of the jalapeno is essentially cooked out and the jalapeno becomes crispier and less juicy, and for the purposes of this disclosure is referred to as a jalapeno chip 20. During this process of converting the jalapeno disc 16 into a jalapeno chip 20, the natural juices and flavors of the jalapeno become infused within the cooking oil 12 resulting in jalapeno flavored cooking oil 13. When the cooking oil 12 is sufficiently infused with flavor, jalapeno chips 20 are removed from the oil.

In a second embodiment, a flavor infused snack product 19 may be produced in the following innovative manner. Again referring to FIG. 1, a cooking vessel 10 is shown into which flavored cooking oil 13 may be placed. The cooking vessel 10 may be a conventional pan suitable for heating flavored cooking oil 13 to a temperature sufficient to cook the selected food item. A heating element 11 may be used to heat the flavored cooking oil 13. The temperature range used with flavored cooking oil 12 to cook or pop an item is known in the art and may be chosen with the sound judgment of a person of skill in the art. Next an uncooked food item may be placed in the flavored cooking oil 13. The food item may be allowed to cook until the flavored cooking oil 13 has infused the food item with the desired flavor, and the food item has obtained the desired intensity, appearance, and consistency. The resulting cooked food item is referred to as a flavor infused snack product or flavor infused food item 19. The desired appearance and consistency may be chosen with the sound judgment of a person of skill in the art. Non-limiting examples of an uncooked food item that may be used to produce a flavor infused snack product 19 are un-popped popcorn kernels, potato slices, crackers, biscuits, and pickles. At this point the flavor infused snack product 19 may be removed from the cooking vessel 10. The resulting flavor infused snack product 19 has now been infused with a vivid and intense flavor that is truer to the natural flavor of the original flavoring agent.

In one non-limiting example of this innovative method, uncooked popcorn kernels are placed into heated jalapeno-flavored cooking oil 13. As the popcorn kernels pop, the popped kernels 14 are infused with the jalapeno-flavored cooking oil 13. The popped popcorn kernels 14 infused with the jalapeno-flavored cooking oil 13 may be served by themselves or alternatively in combination with the jalapeno chips 20.

In another embodiment, a combination snack product may be produced in the following manner, an amount of a first flavor infused snack product may be combined with an amount of a second flavor infused snack product. The resulting combination snack product may then be placed in a container for storage or for consumption.

In still another embodiment, a combination snack product may be produced in the following manner, an amount of two or more flavor infused snack products may be further combined with the cooked flavoring agent. The resulting combination snack may then be placed in a container for storage or for consumption. By way of a non-limiting example, the popped popcorn kernels 14 infused with the jalapeno-flavored cooking oil 13 may be served in combination with the jalapeno chips 20 and another infused snack product such as jalapeno-flavored potato chips.

The embodiment described above is a single embodiment of the broader invention. Any kind of fried product can be produced in an embodiment of the invention. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1) A method comprising the steps of:
(a) heating cooking oil to the desired temperature;
(b) placing flavoring agent into said heated cooking oil and cooking said flavoring agent until the desired flavor intensity, appearance, and consistency is achieved, thereby infusing said cooking oil with the flavor of said flavoring agent;
(c) removing said flavoring agent from said flavored cooking oil;
(d) placing a first uncooked food item into said flavored cooking oil and cooking said first uncooked food item until the desired flavor intensity, appearance, and consistency is achieved, thereby infusing said first uncooked food item with the flavor of the flavored cooking oil; and
(e) removing said first flavor infused food item.

2) The method according to claim 1 whereby said oil is chosen from a group comprising popcorn oil, grapeseed oil, canola oil, corn oil, peanut oil, sunflower oil, flaxseed oil, and olive oil.

3) The method according to claim 1 whereby said flavoring agent comprises jalapeno peppers.

4) The method according to claim 1 whereby said flavoring agent comprises non-jalapeno peppers.

5) The method according to claim 1 whereby said flavoring agent comprises pickles.

6) The method according to claim 1 whereby said flavoring agent comprises bacon.

7) The method according to claim 1 whereby said flavoring agent comprises garlic.

8) The method according to claim 1 whereby said flavoring agent comprises ginger.

9) The method according to claim 1 whereby said flavoring agent comprises basil.

10) The method according to claim 1 whereby said first uncooked food item comprises un-popped popcorn kernels.

11) The method according to claim 1 whereby said first uncooked food item comprises potato slices.

12) The method according to claim 1 whereby said first uncooked food item comprises crackers.

13) The method according to claim 1 whereby said first uncooked food item comprises biscuits.

14) The method according to claim 1 whereby said first uncooked food item comprises pickles.

15) The method according to claim 1 further comprising step:
(f) combining said first flavor infused food item with said flavoring agent prior to consumption.

16) The method according to claim 1 further comprising steps:
(g) placing a second uncooked food item into said flavored cooking oil and cooking said second uncooked food item until the desired flavor intensity, appearance, and consistency is achieved, thereby infusing said second uncooked food item with the flavor of the flavored cooking oil; and
(h) removing said second flavor infused food item.

17) The method according to claim 16 whereby steps (d) and (g) are performed simultaneously.

18) The method according to claim 16 further comprising step:
(i) combining said first flavor infused food item with said second flavor infused food item.

19) The method according to claim 18 further comprising step:
(j) combining said first and second flavor infused food items of step (i) with said flavoring agent prior to consumption.

20) The flavor infused food item made by the method of claim 15.
